(19) United States
(12) Patent Application Publication
(10) Pub. No.: US 2005/0259252 A1
(43) Pub. Date: Nov. 24, 2005

(54) Method and device for recording optical near field interaction signals

(76) Inventors: Rainer Hillenbrand, Igling (DE); Fritz Keilmann, Berg (DE); Thomas Taubner, Munich (DE)

Correspondence Address: BUCHANAN INGERSOLL PC, 1835 MARKET STREET, 14TH FLOOR, PHILADELPHIA, PA, 19103-2985, US

(21) Appl. No.: 10/519,349

(22) PCT Filed: Jun. 23, 2003
(86) PCT No.: PCT/EP03/06587

§ 371 Date: Jul. 8, 2005

(30) Foreign Application Priority Data
Jun. 24, 2002 (DE) 102 28 123.8

(51) Int. Cl. G01J 3/28

(52) U.S. Cl. 356/326

(57) ABSTRACT

Described are methods for acquiring optical near-field interaction signals in the infrared spectral region, involving the steps of: illuminating an object combination comprising at least two objects (1, 2) with infrared radiation so that an infrared near-field coupling is produced between the objects (1, 2); and acquiring the scattered light which is scattered by the object combination, which scattered light comprises a fraction(s) that has been modified as a result of the near-field coupling; wherein at least one of the objects (1, 2) comprises a polar material which at least in part comprises a polar solid-state structure; and during illumination in at least one of the objects (1, 2) with the polar material at least one phonon resonance is excited with which the modified fraction(s) of the scattered light is strengthened. Also described are applications of the method in the fields of metrology, data storage technology and optical signal processing.

The invention relates to methods for acquiring optical near-field interaction signals according to the preamble part of claim 1, as well devices for implementing and applying such methods.

Due to diffraction, the spatial resolution of conventional optical methods, e.g. in microscopy or data storage applications, is limited to approximately half the wavelength of the optical radiation used. In order to increase the resolution, light of the shortest possible wavelength is used. For example, as suitable blue light sources became available, a considerable improvement in resolution and thus a considerable increase in storage density was achieved. If essentially the same wavelength is used for the reading and writing of data, the diffraction limit is accepted as a principal limitation. There is however a problem if data is written with radiation involving extremely short waves, such as e.g. with ion rays (see S. Kalbitzer in “Applied Physics A”, vol. 71, 2000, pages 565-569). Focused ion rays make it possible to achieve a storage density of up to the Tbit/cm² range. However, due to the diffraction limit, data of such storage density cannot be read using conventional optical methods.

The diffraction limit can be overcome by the application of near-field optical methods. These methods were first developed for near-field microscopy (scanning near field optical microscopy, SNOM) in which surface characteristics of a sample are registered at spatial resolutions below 10 nm by observing the near-field interaction of a probe with the sample (see e.g. R. Hillenbrand and F. Keilmann in “Applied Physics Letters”, vol. 80, 2002, pages 25-27, and in “Physical Review Letters”, vol. 85, 2000, pages 3029-3032). The high resolution in the nm-range is achieved by means of the principle of the apertureless scanning tip (see e.g. U.S. Pat. No. 4,947,034). While near-field optical microscopy offers the advantage of improved spatial resolution, this advantage has however so far been associated with very considerable measuring expenditure. It is necessary to filter the near-field fraction out of the scattered light which the probe radiates to the surroundings. The near-field fraction is that fraction of the scattered light, which is determined by the near-field interaction between the probe and the sample, wherein said fraction sensitively depends on the surface characteristics of the probe. The near-field fraction is first over-irradiated by the remaining scattered light and after filtering out has a low signal-to-noise ratio (SNR).

The application of optical near-field methods for reading optical data storage devices is for example described by Y. Martin et al. in “Applied Physics Letters”, vol. 71, 1997, pages 1-3, and in U.S. Pat. No. 5,602,820. Data readout takes place analogously to the operation of a near-field optical microscope, namely by registering the near-field interaction between a probe (SNOM tip) and the surface of a data carrier. While Y. Martin et al. were able to read out data with storage densities of up to the range of Tbits/cm², the same problems occurred as in optical near-field microscopy. The reading out of a bit corresponds to measuring the local surface characteristics of the data carrier. Due to the poor SNR, up to now a relatively long measuring time was required to obtain a reliable reading. For practical purposes, optical near-field reading of data has not been suitable so far.

There is an interest in near-field optical methods with which methods the limitations of conventional techniques can be overcome, with these methods being characterized in particular by an improved SNR.

B. Knoll and F. Keilmann expanded optical near-field microscopy to acquire special sample characteristics to include the infrared spectral region. For example it was found that the infrared near-field interaction depends on the conductivity of an examined silicon sample (see B. Knoll et al. in “Applied Physics Letters”, vol. 77, pages 3980-3982). Infrared near-field microscopy thus makes it possible to record the characteristics of charge carriers in silicon at a high spatial resolution (30 nm). Furthermore, chemical compounds on surfaces were recorded by infrared near-field microscopy at a spatial resolution of approximately 100 nm (see B. Knoll et al. in “Nature”, vol. 399, 1999, pages 134-136). However, these investigations on special measuring objects have not so far provided a solution for the above-mentioned problem, namely in the case of probe-sample interaction to more effectively record near-field fractions from the scattered light.

A theoretical description of interaction effects between a spherical object and a surface appears in the publication by P. K. Aravind et al. in “Surface Science”, vol. 124, 1983, pages 506-528. This description is limited to the illustration of the strengthening of the field between the object and the surface. It is shown that resonantly strengthened alternating fields occur, wherein resonance strengthening is caused in particular by plasmons or phonons. P. K. Aravind et al. do not provide any pointers to the light radiation of the system under consideration, or to interactions between several objects. Furthermore, no applications of field strengthening implemented in practical applications are described.

Lastly, infrared reflection spectroscopy is known as a common tool in physical and chemical analysis. For example, molecular bonds can be proven in a material-specific way in the infrared spectral region. Conventional reflection spectroscopy on polar materials with a dielectric constant<0 is associated with a disadvantage in that the spectroscopically detectable interactions occur in a relatively wide band. If a sample comprises several components which spectrally differ, because of the wide-band nature of the interactions it cannot be guaranteed that with conventional infrared reflection spectroscopy the spectral difference and thus each one of the components is detectable.

It is an object of the invention to provide improved methods for acquiring optical near-field interaction signals in the infrared spectral region, and to provide devices for implementing the methods, with which methods and devices the disadvantages of conventional techniques can be overcome. It is an object of the invention to carry out, in particular, near-field measurements with an increased signal-to-noise ratio and to carry out infrared measurements with increased spectral selectivity. It is a further object of the invention to provide new applications of near-field interaction signals in the infrared spectral region.

These objects are met by means of methods and devices with the features according to claims 1, 20 or 26. Advantageous embodiments and applications of the invention are stated in the dependent claims.

A basic idea of the invention consists of acquiring and/or processing optical near-field interaction signals in the infrared spectral region in that at least one object combination comprising at least two objects is illuminated with infrared radiation so that an infrared near-field coupling is produced between the objects, and the scattered light which is scattered by the object combination is acquired, which scattered light comprises a fraction that has been modified as a result of the near-field coupling. According to the invention at least one of the objects comprises a polar material which at least in part comprises a polar solid-state structure. Advantageously, during illumination of the object combination at least one phonon-polariton resonance is excited with which the modified fraction in the scattered light is amplified.

Optical near-field interaction signals which are recorded and/or processed according to the invention are generally formed by electromagnetic or electrical fields which are modified by the near-field interaction between the objects. The term “acquiring” generally refers to detecting (or measuring) with a detector device, or receiving (or resonant coupling) with an adjacent object which acts like an aerial. Processing of the optical near-field interaction signals comprises evaluation, demodulation and/or filtering of the signals of the detector device, or forwarding of resonant excitations to adjacent objects. Accordingly, a first embodiment of the invention is directed towards detection- and measuring applications of the strengthening, according to the invention, of infrared near-field coupling, while a second embodiment relates to applications in optical modulators, in particular in optical circuits.

According to the first embodiment of the invention, it is proposed that scattered light measuring in the infrared spectral region on an object combination (sample-probe combination) be improved to the effect that, as a sample and/or as a probe, a material is used which at least partly comprises a polar solid-state structure, and in which material with infrared illumination resonant coupling of phonons to the optical field is excited, which resonant coupling is detectable in the scattered light as a strengthened near-field fraction. At least one phonon resonance is excited, which results in the strengthening of at least one near-field fraction in the scattered light so that near-field optical measuring can be carried out at a considerably improved signal-to-noise ratio. Local changes in the refractive index on the sample lead to a shift in the resonance frequency and are thus effectively detectable. Advantageously, the near-field resonance is sensitively dependent on the near-field interaction with the immediate surroundings and is thus eminently suited as a local sensor with extremely high spatial resolution. Furthermore, the infrared-optical excitation of phonon polaritons in a polar material is associated with the advantage that an infrared near-field resonance of an extremely narrow bandwidth occurs. It is thus the first time that for example in infrared reflection spectroscopy even infrared bands which are spectrally very close to each other can be detected separately.

The term “combination of a sample and a probe” generally refers hereto a system of two objects which are arranged so as to be spaced apart at little distance (e.g. up to 100 nm) or which objects contact each other (or are embedded one into the other). During exposure to infrared radiation, resonant excitation of phonon polaritons takes place in at least one of the objects. Generally speaking, in the following the object whose characteristics are to be recorded by means of the scattered-light measuring according to the invention is referred to as the sample, while the respective other object, in which during infrared radiation resonant excitation of phonon polaritons takes place or by which object during infrared radiation local phonon polaritons are locally excited in the sample, is referred to as the probe. According to preferred embodiments of the invention, the probe comprises a solid-state surface, an adsorbate which is formed on a solid-state surface, or a solid, liquid or gaseous volume material. The solid-state surface can be flat or curved. The probe comprises, for example, a scanning tip as it is known from near-field microscopy, a bar-shaped probe tip, which can for example be used as a reading head when reading out stored data, or one or several particles which are arranged so as to be embedded or freely suspended in a solid, liquid or gaseous medium or so as to be adsorbed on a carrier surface.

At least one of the objects, at its side facing the other object during measuring, at least partly comprises at least one condensed material of polar solid-state structure. Such a material features a polar connection between the atomic modules of the solid body. Such a connection has a polar character if the bond is characterised by an asymmetric charge distribution. This is the case in particular in an ion bond or a bond with dipole moment or a polarised covalent bond or a bond with an ionic fraction. One object has at least in part a polar solid-state structure. This means that the object comprises several parts, at least one of said parts having a polar solid-state structure (e.g. the probe tip of a scanning tip) and/or the polar solid-state structure is only formed in parts of the respective object material. Thus the material with polar solid-state structure can comprise an ion crystal or an amorphous material with a short-range order. In the amorphous material, the lattice vibrations which are resonantly excited according to the invention are local vibrations. Generally speaking, a material is suitable as a sample and/or probe if the real component of the dielectric constant in a frequency range of its dispersion curve becomes smaller than 0. This is in particular also the case with amorphous materials, such as e.g. SiO₂ (glass).

Particular advantages are achieved if the sample and/or the probe comprise(s), at least in part, silicon carbide (SiC). Silicon carbide has the advantage of a large and substantially localised optical near-field coupling. Furthermore, SiC has outstanding mechanical, thermal and chemical stability so that it is suitable for a wide range of applications in microscopy, optical data storage technology, and sensor technology. SiC is a material from which extremely high storage densities (Tbit/cm²) are expected; a material which due to its physical and chemical stability features high data security. In optical data storage technology, the method according to the invention is preferably implemented with a probe made from SiC since this probe is extremely durable and provides high signals, which has a favourable effect in particular in spatially high-resolution (sub-10 nm range) optical infrared microscopy.

Advantageously, the fraction of the measured scattered light, which fraction is modified by near-field coupling, can be subjected to spectral analysis. Phonon resonance corresponding to several components or phases can be acquired in the sample with a high degree of selectivity.

The invention also covers sample-probe combinations and measuring arrangements for scattered-light measuring in the infrared spectral region, which combinations and arrangements are adapted for implementing the method according to the invention according the above-mentioned first embodiment. Measuring arrangements according to the invention are in particular characterised by a measuring probe which at least partly comprises a material with a polar solid-state structure.

One embodiment of a measuring arrangement according to the invention can for example be designed like a device for apertureless near-field microscopy, as it is known from DE 100 35 134, which herewith is completely incorporated into the present patent application by reference, as far as the interferometric near-field microscopy described therein, and the device provided for this, are concerned. Depending on the extent of the resonance increase generated according to the invention, the fraction modified as a result of the near-field interaction can also be recorded directly by means of optical detectors, if need be in combination with filters.

The invention has the particular advantage that at least part of the irradiated sample-probe system contributes to a resonance during exposure to infrared irradiation so that an increased near-field fraction is scattered. Surface characteristics become detectable with increased contrast. Due to the improvement in SNR, local readings can be carried out with a shortened measuring time. This characteristic is of particular significance in relation to the reading-out of data with extreme storage densities under practical conditions.

According to the above-mentioned second embodiment of the invention, acquiring the modified fraction of the scattered light means that resonant excitation of at least one object which is adjacent to the object combination takes place. The phonon polaritons, which are resonantly excited according to the invention by exposure to infrared radiation, cause the generation of phonon polaritons in at least one adjacent object, wherein a corresponding resonant strengthening of the field occurs. The resonant excitation state can be forwarded along at least one series of objects. During forwarding, by way of targeted influencing of individual objects or of their surroundings, forwarded near-field interaction signals can be modulated. The row of objects, of which row there is at least one, can comprise branching or can form a network. The objects comprise for example particles with typical sizes ranging from 1 nm to 100 μm, which are arranged on a substrate with typical spacing ranging from 1 nm to 10 μm.

According to the invention it can be provided for the physical characteristics of one or several of the objects or of their surroundings to be modulated, for example by electromagnetic, electrical or magnetic fields. Modulation comprises for example a predetermined change in the crystal structure, the band structure, the charge carrier density or the like. As a result of modulation, forwarding of the near-field interaction signals is modulated accordingly. In a way that is different to the situation involving conventional optical circuit technologies, the processing, according to the invention, of optical near-field interaction signals provides a special advantage in that the excited phonon resonances are within extremely sharp spectral bands. As a result of this, switching states (e.g. On/Off) can be set or transmitted with improved reliability.

A device for implementing the method according to the invention according to the above-mentioned second embodiment preferably consists of an optical modulator for acquiring or processing optical near-field interaction signals in the infrared spectral range. According to a preferred embodiment, the modulator comprises a solid substrate on which a multitude of particle-shaped objects are arranged, wherein at least a part of these objects can be modulated with external fields. Preferably, the optical modulator comprises at least one illumination device and/or at least one detector device, which are/is also arranged on the substrate. Accordingly, the invention also relates to an optical circuit for near-field optical processing of signals.

Further advantages and details of the invention are set out in the following description of the enclosed drawings. The following are shown:

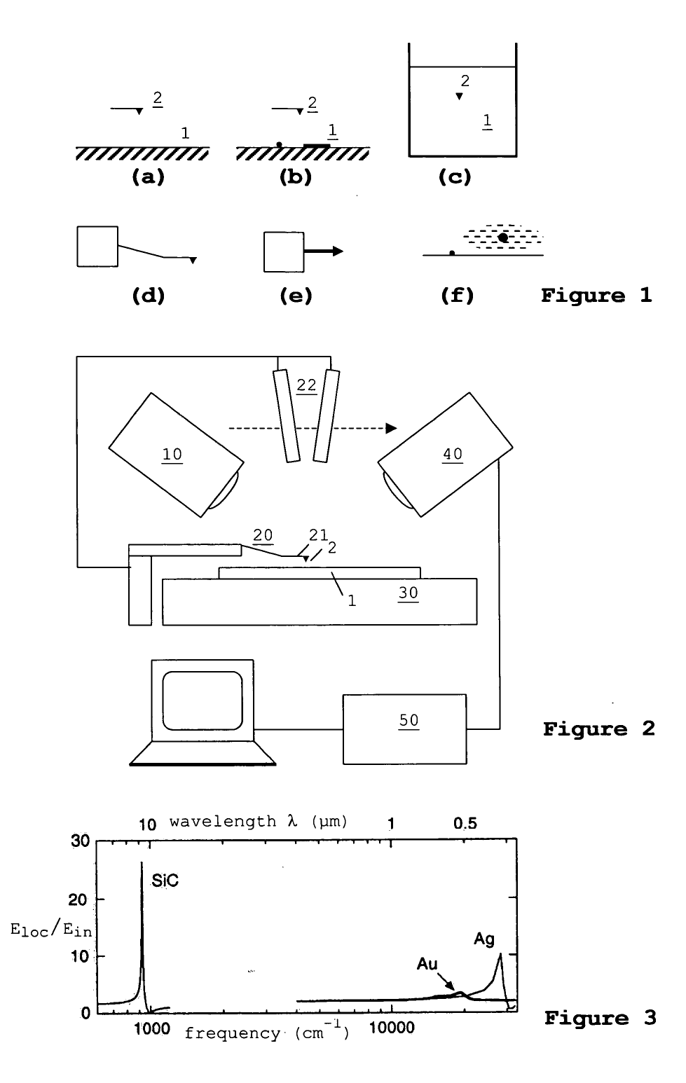

FIG. 1: diagrammatic illustrations of various samples and probes for implementing the method according to the invention;

FIG. 2: a diagrammatic overview of an embodiment of a measuring arrangement according to the invention;

FIG. 3: a graph to illustrate the phonon resonance excited according to the invention;

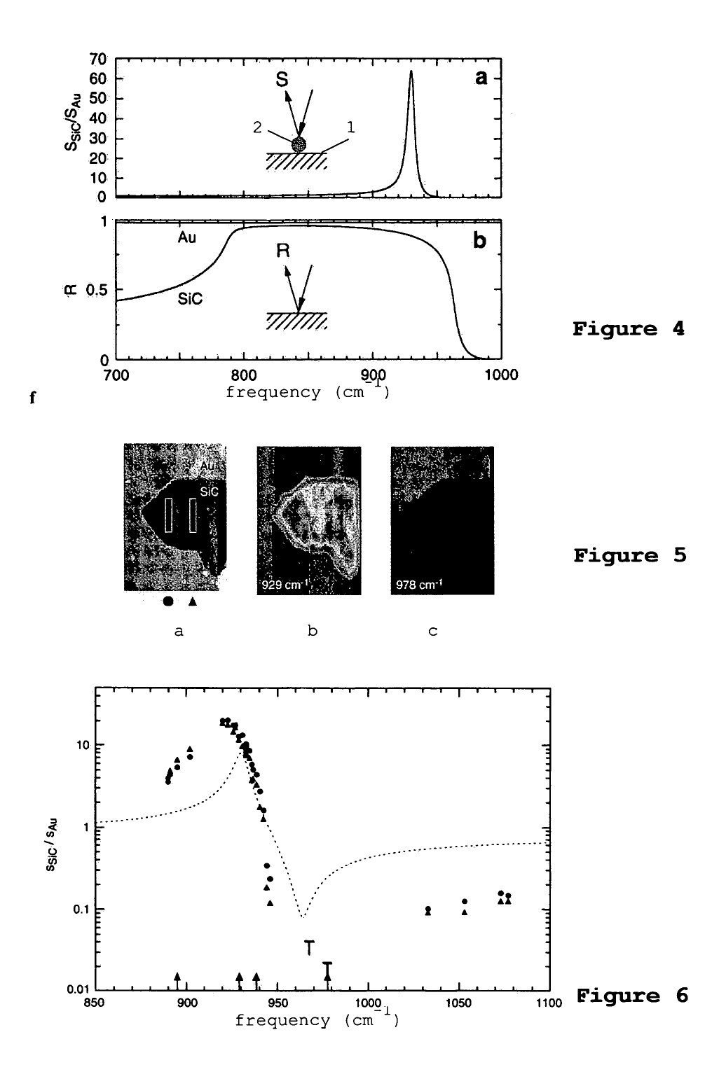

FIG. 4 graphs to illustrate the wavelength selectivity of the phonon resonance excited according to the invention;

FIG. 5: examples of near-field microscopy images obtained according to the invention;

FIG. 6: graphs to illustrate the phonon-strengthened near-field coupling to SiC; and

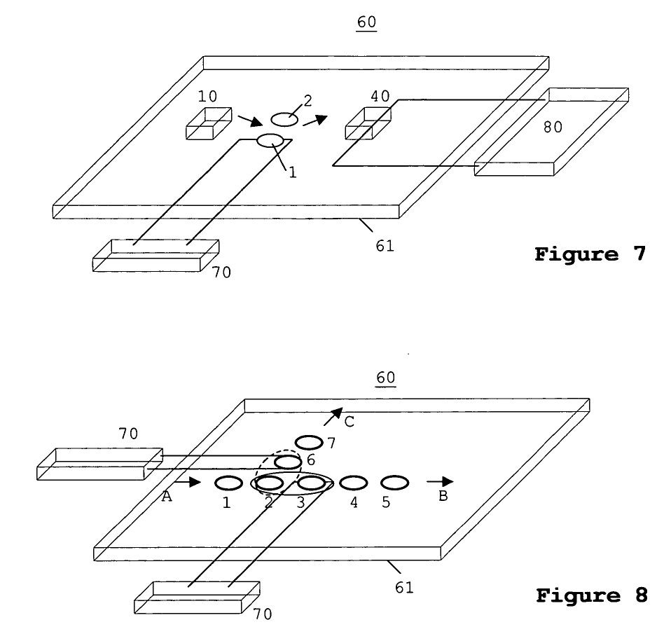

FIGS. 7, 8: diagrammatic illustrations of embodiments of optical modulators according to the invention.

Below, the invention is described by way of example, with reference to the use of SiC as a polar material for phonon-coupled near-field strengthening. However, implementation of the invention is not restricted to this material. Instead, other polar dielectric materials can also be used, in particular III-V-, IV-IV- and II-VI-semiconductors, minerals such as e.g. calcite or glass, or ferroelectric materials. Matching laser light sources with suitable infrared emissions (in particular quantum cascade lasers) are available for these material classes.

### Theoretical Basis

Optical near-fields occur in proximity of any illuminated object. Optical near-fields are generated by the interaction between the illuminated material and the incident electromagnetic field; they drop off significantly within typical distances of approximately 10 to 100 nm. According to the invention, optical near-fields are strengthened by coupling (near-field coupling) with lattice vibration (phonons) in polar dielectric materials (such as e.g. SiC). In material-dependent frequencies, which are determined by the phonons, strengthening occurs as a sharp resonance (near-field resonance). Surprisingly, it has been shown that near-field resonance is sharper and more pronounced than plasmon resonance, which is known from metals (see below). Elemental vibration excitation of a polar solid-state body is also referred to as phonon-polariton, which as a quasi-particle comprises both mechanical and electromagnetic properties. Excitation of the polariton provides the near-field resonance which is described below.

A small particle from a polar material with the dielectric constant ε_{ρ} (diameter e.g. a=10 nm) is examined, whose surface is exposed to infrared radiation. The field strength of the incident radiation is referred to as Eᵢₙ. The ratio between the optical field E_{loc}, strengthened on the surface of the particle, and the incident field Eᵢₙ(E_{loc}/Eᵢₙ) is determined by the polarisability α of the particle. The polarisability α is calculated as follows:
α=4πa³(εₚ−εₘ)/(εₚ+2εₘ) (1)

In equation 1, a is the diameter of the particle and εₘ is the dielectric constant of the surrounding medium. Near-field strengthening E_{loc}/Eᵢₙ is proportional to α so that a resonance maximum at a frequency exists, where:
Re(εₚ(ω))=−2εₘ (2)

Calculation with dielectric data of metals and e.g. of SiC results in the graphs shown in FIG. 3. The plasmon resonances of small metal particles, e.g. of gold or silver, have relatively low amplitudes in the visible wavelength spectrum. In contrast to this, the phonon resonance of polar, dielectric particles is significantly more pronounced and sharper (this comparison assumes identical particle sizes).

Apart from these findings it is also important that the resonance according to equation (1) sensitively depends on the dielectric constant of the immediate surrounding of the particle. Thus a particle (or a polar material section in an object) can be used as a local sensor for material characteristics in the surroundings. Below, various applications in metrology, data storage- and sensor technology are mentioned by way of example.

According to the invention, phonon strengthening of the near-field coupling between two objects, which objects in this document are generally referred to as sample and probe, are used to record characteristics of the probe with high spatial resolution. Preferably, sample-probe combinations are used as they are known from conventional near-field microscopy with an apertureless optical scanning tip and a flat probe. The end of the scanning tip for example has the shape of a small particle (spherule) with a radius a, located at a distance z from the sample surface. Depending on the application, the surface of the sample material can at least partly comprise a polar dielectric material, and the probe material can be non-polar. Alternatively, this can be the other way round.

FIG. 4 shows the measurable signals in the near-field coupling according to the invention between the sample and the probe (FIG. 4a) and by comparison in conventional reflection measuring (FIG. 4B). The sample 1 comprises SiC and has a plane surface which is contacted by the probe 2 in the form of a Pt particle with a radius a <<λ.

When the probe 2 is illuminated, an image dipole is induced in the sample 1, with the polarisability of the image dipole being αβ, where:
β=(ε_{S}−1)/(ε_{S}−1) (3)
(ε_{S} is the dielectric constant of the sample 1). Near-field coupling of the probe dipole and the image dipole (in sample 1) results in an effective polarisability which in an electrostatic approximation is:
α_{eff}=[α(1+α)]/[1−αβ/16π(a+z)³] (4)

The coupled system can thus become resonant as a result of the influence of the sample 1 or the probe 2 or as a result of both. The intensity S of the scattered light which can be measured at a distance from the sample-probe combination, i.e. in the far field, depends on α_{eff}according to:
S≈|α_{eff}|² (5)

The simulated curve shown in FIG. 4a shows the ratio S_{SiC}/S_{Au} of the intensities of scattered light which are determined on a SiC sample and on an Au sample. There is an extremely sharp resonance at a frequency of 929 cm⁻¹. The scattered light during interaction with SiC exceeds the corresponding value during interaction with Au by approximately a magnitude of 2. This strengthening is a significant advantage of the invention. FIG. 4b shows the reflection which is measurable in the far field: for Au it shows a value of almost 1, and for SiC it shows the gradient which is known per se, with a maximum of 790 cm⁻¹ and 950 cm⁻¹. This result illustrates that in addition to the high local selectivity, the near-field coupling advantageously is also characterised by a spectral narrowing. This spectral narrowing can radically improve the ability to differentiate sample materials (e.g. material phases).

By way of example, FIGS. 5 and 6 show experimental results with which the phonon-strengthened near-field resonance is confirmed. The left part of FIG. 5 shows a section of a partially gold-plated SiC surface. The size of the sample depicted is 1.6·2.3 μm². The thickness of the Au layer is 10 nm. The rectangular fields show the SiC regions in which the results according to FIG. 6 were obtained. The coated SiC surface was arranged as a sample in an atomic force microscope (AFM) which had been modified to carry out the measurement according to the invention. The probe was a Pt-coated cantilever scanning tip with a tip radius of approximately 20 nm. To take the topography image (FIG. 5a), the measuring arrangement was operated in the AFM mode, i.e. the topography of the gold plating was recorded by means of conventional atomic force microscopy.

At the same time the scanning tip (probe) was subjected to focused radiation in the infrared spectral range by means of a tunable CO₂ laser or quantum cascade laser. The backscattered light was interferometrically acquired (see below, FIG. 2, and DE 100 35 134). By detecting the backscattered amplitude s=|α_{eff}|, the local near-field interaction between the probe and the sample surface is acquired directly. The measuring of s takes place in a spatially resolved manner in that the interesting region of the surface is scanned step by step.

FIGS. 5b and 5c qualitatively illustrate the determined s-values. The larger the s-value the brighter the associated location of measuring appears on the drawing. FIG. 5b shows that as a result of phonon-strengthened resonance during radiation with 929 cm⁻¹, the signal s is greatly increased. Even at a small change in the illumination wavelength to 978 cm⁻¹ there is a contrast reversal. Strengthening of the signal s disappears; the SiC region in FIG. 5b appears darker.

FIG. 6 shows quantitative measuring results which were measured in the regions marked in FIG. 5a (averaged across all measured values in the marked regions; readings taken on the separate regions which are marked by a circle or a triangle). The results of the readings (circles and triangles in FIG. 6) show the resonance at 929 cm⁻¹. Resonance strengthening reaches a factor of 20 relative to the signal measured on Au. The dotted curve in FIG. 6 is based on simulation data according to the model system shown in FIG. 4a. There is a discrepancy between the theoretically calculated maximum and the experimental data, a discrepancy which is explained by limitations of the approximations used in the model calculations. For measuring using SiC in the sample or the probe, corresponding with the measured results, exposure to infrared radiation in the region of 890 cm⁻¹ to 940 cm⁻¹ is preferred.

### First Embodiment: Sample-Probe Combination for Detection Applications

The method according to the invention is generally implementable with sample-probe combinations of which at least a part comprises a polar solid-state structure. The form of the sample and the probe is selected depending on the specific measuring requirements, as is diagrammatically illustrated in FIG. 1.

According to FIG. 1a, the sample 1 is a plane or curved solid-state surface, which if applicable carries an adsorbate, while the probe 2 is a scanning tip. To determine the dielectric characteristics of the sample 1, the scanning tip 2 is arranged so as to contact the sample 1 or so as to be spaced apart (e.g. up to 100 nm) from said sample 1. At least one component comprises a polar material. During exposure to infrared radiation, phonon polaritons are resonantly excited, which phonon polaritons produce a selectively detectable scattered-light fraction which in the above-described way sensitively depends on the dielectric characteristics of the sample 1 in the surroundings of the probe 2.

According to FIG. 1b, the sample 1 comprises an adsorbate on a solid-state surface, while probe 2 again comprises e.g. a scanning tip. The adsorbate 1 is for example formed by individual molecules, particles or a layer-shaped adsorbate. The adsorbate can also be embedded in the surface or can be arranged below the surface underneath a cover layer. The arrangement below the surface can for example take place to a depth of 100 nm, preferably 1 to 3 nm. When the probe 2 is exposed to infrared radiation, a scattered-light fraction is generated which depends on the dielectric characteristics of the adsorbate 1. In the design according to FIG. 1b, the samples, the probe and/or the solid-state surface can comprise a polar material which causes the near-field interaction according to the invention, which near-field interaction is resonantly distorted in height.

According to FIG. 1c, the probe 2 can be embedded in the sample 1 which is a solid, gaseous or liquid material. For example, a multitude of suspended particles are provided as a probe 2, which particles during exposure to infrared illumination scatter infrared light with the resonantly modified fraction of scattered light. The scattered light fraction which is of interest is sensitively dependent on the dielectric characteristics and thus in particular on the composition of the sample 1.

FIGS. 1d to 1f show diagrammatically different designs of the probe 2 as an AFM scanning tip (d), a reading head (e) or as a solid-phase adsorbed or suspended particle (f). At least a part of the sample-probe combination has characteristic cross-sectional dimensions which are selected small enough for the desired phonon-polariton resonances to occur. The dimension is preferably smaller than or approximately equal to the wavelength of the infrared radiation used, which can range e.g. from 2 μm to several hundred μm. For example, the dimension of the point of the scanning tip 2 (FIG. 1a, b) or of a particle 2 (FIG. 1c) ranges from 0.1 nm to 5 μm, preferably from 1 nm to 1000 nm.

It should be emphasized that the probe 2 does not necessarily have to comprise a polar solid-state structure. Instead, if the sample 1 comprises a polar material (e.g. FIG. 1a), a non-polar scanning tip 2 may also be used. According to the principle of the mirror charge, when the scanning tip 2 is illuminated by infrared light, near-field coupling with the sample 1 results in a mirror dipole being resonantly excited in said sample 1.

Illumination of the sample-probe combination with infrared radiation takes place depending on the specific application. For example, exposure to radiation in free space (see FIG. 2) or coupling by way of optical waveguides is envisaged.

### Measuring Arrangement for Measuring Near-Field Scattered Light

By way of example, FIG. 2 shows a measuring arrangement for measuring scattered light in the infrared spectral region, comprising an illumination device 10, a probe device 20, a sample holder 30, a detector device 40 and a control device 50. Essentially, the measuring arrangement can be designed like a conventional AFM so that further details need not be discussed in this document. The probe device 20 and the sample holder 30 can be displaced relative to each other in the x-, y- and z-directions. The probe device 20 comprises a cantilever tip 21 (scanning tip) comprising a probe 2, whose current oscillation state is recorded by means of a laser-detector combination 22. As an alternative, control of the cantilever tip 21 can take place by means of other detection methods, for example by piezoelectric detection. The cantilever tip 21 with the probe 2 can be made to oscillate in the z-direction. The z-oscillation frequency is for example 10 to 300 kHz. The oscillation amplitude in the z-direction is for example 20 nm. The illumination device 10 and the detector device 40 preferably interact in the way described in DE 100 35 134 (demodulation technique). To record the near-field fraction s, for example a phase-sensitive lock-in reading takes place at a sum frequency from the z-oscillation frequency of the probe 2 (or of its higher harmonic) and a differential frequency synthetised in the illumination device, which differential frequency is offset in relation to the infrared illumination radiation.

The measuring arrangement according to FIG. 2 is in particular set up for near-field optical microscopy. In other applications of the invention the design is to be modified, wherein in each case a combination of the sample 1 and the probe 2 (for example the storage medium and data reading head) and a combination of illumination devices and detector devices are provided for acquiring the resonantly increased near-field interaction between the sample and the probe.

### EXAMPLES OF APPLICATIONS

(a) Optical Near-Field Microscopy

By means of phonon-polariton-resonant signal strengthening, the invention provides a significant increase in contrast (see FIG. 5b) when compared to conventional near-field microscopy. This not only makes possible faster data acquisition (in particular if a resonant probe is used) but also expansion to samples with a surface composition which is characterised by smaller differences in the dielectric constant. In particular if a resonant probe is used, smaller differences in the refractive index can be differentiated with higher sensitivity. This is significant in applications involving near-field microscopy in biochemistry, e.g. when differentiating between proteins and lipids.

By interferometrically measuring the near-field fraction (demodulation technique) and evaluating higher harmonics of the z-oscillation frequency of the probe, the spatial resolution can be improved to far less than the probe radius.

(b) Data Storage Technology/Optical Reading of Stored Data

In the use of polar storage media, the invention makes it possible to read out bit structures with characteristic dimensions of 10 nm. This corresponds to a storage density in the Tbit/cm² range. Such bit structures can be written in crystalline materials (e.g. SiC) by ion radiation (local transformation to non-crystalline or amorphous structures).

With the use of a polar storage medium, reading heads from a non-polar material (e.g. metal) or a polar material can be provided as probes. Reading heads from polar materials, in particular SiC, are preferred on account of their excellent durability, high signal amplitude and increased contrast.

A data storage device is essentially designed like the measuring arrangement according to FIG. 1, wherein if necessary the probe device 20 is modified as a reading head (see e.g. FIG. 1e) and the sample holder 30 is modified as a carrier of the storage medium. If required, the illumination device is set to a fixed wavelength which matches the respective combination of sample and probe.

It is a surprising feature of the invention, which feature deviates from the course of development up to now, in that data storage devices with an increased storage density are read out optically with infrared light of a longer wavelength than is the case with light sources (e.g. blue light) that have hitherto been used for optical data readout.

(c) Sensor Technology

Scattered-light measuring, according to the invention, on sample-probe combinations of which at least one component comprises a polar material, makes possible applications in chemical sensor technology and physical metrology. For example, the arrangement according to FIG. 1b can be used for detecting adsorbed materials 1 on a surface. Alternatively, materials can be detected which are embedded in the surface or in the volume. Since near-field coupling is sensitively dependent on the dielectric constants of the objects involved, the strength of the resonance increase allows conclusions concerning the materials involved. For example, the dielectric constant of a semiconductor depends on doping. With the method according to the invention, doping agent distributions can be measured with great sensitivity. Preferably, spectrally selective scattered light measuring or spectral analysis of the acquired scattered light takes place.

A further application consists of the provision of test samples in optical near-field microscopy. A test sample comprises a smooth surface (without topography) with a strong optical contrast, e.g. by implantation of extraneous matter or structural changes.

Furthermore, in physical metrology, applications in temperature sensing or pressure sensing are possible. Since the lattice vibrations in the sample or in the probe sensitively depend on environmental conditions, they also have an effect on near-field coupling. Thus it is also possible to register temperature values or pressure values in the interior of liquid or solid samples.

In chemical sensor technology, nanostructures can be chemically analysed at high spatial resolution. The invention also makes possible local structural analyses of crystals, or the analysis of phase changes (e.g. in biomineralisation).

In chemical sensor technology, samples can also be analysed with high spectral (or material) selectivity. If a sample, for example, comprises a composite material in which the components differ by small chemical modifications, conventional infrared spectroscopy would only return strongly overlapping wide areas of resonance. However, according to the invention, spectral narrowing is achieved as a result of near-field interaction. The resonances specific to the component would no longer overlap and would therefore certainly be distinguishable. Accordingly, for example, the progress of phase changes or chemical reactions in solid bodies or adsorbates can be observed.

A composition of calcium phosphate and calcium hydrogen phosphate, which component biominerals are for example of interest for implantation purposes, is one example of a composite material examined according to the invention. With scattered light measuring according to the invention, the degree of mineralisation of a composition can be recorded even in the smallest of sample volumes.

(d) Further Applications

Further applications of the invention include the investigation of non-linear optical phenomena which applications become possible through the provision of high field strengths near a strongly curved polar solid body (nanofocusing).

### 2^{nd} Embodiment: Resonant Forwarding of Phonon Polaritons

The method according to the invention can also be applied in optical data processing and in the design of optical circuits as will be explained below with reference to FIGS. 7 and 8. According to FIG. 7, a basic form of an optical switch 60 comprises a substrate 61 on which at least two objects 1, 2 are arranged. The objects 1, 2 are nanoparticles of which at least one comprises the above-characterised polar material. The spacing between the objects 1 and 2 is for example 100 nm. The substrate 61 comprises for example silicon. With an illumination device 10, the object combination 1, 2 is illuminated with infrared light. The fraction of the scattered light modified by the near-field coupling is detected with the detector device 40 (e.g. semiconductor diode).

By modulating the physical characteristics, for example of object 1, the formation of the near-field resonance between the two objects 1, 2 can be switched on or off. In the case of a ferroelectrical particle 1, modulation involves for example electrical switching with a modulator 70 (modulatable electrical voltage source). The electrical modulation is impressed in accordance with the light measured with the detector device 40 and is evaluated in a data processing device 80.

While FIG. 7 illustrates the basic form of an optical circuit device through modulation of infrared light, the diagrammatically illustrated optical modulator according to FIG. 8 shows a section from a network comprising a multitude of particle-shaped objects 1 to 7. Analogous to the above-mentioned principles, for example the objects 3 and 6 can be modulated with external fields. Depending on the setting of the particle characteristics, so that resonant coupling to the adjacent objects (see oval markings) may or may not take place, an excitation state which was originally coupled according to arrow A can be forwarded on neither, on one, or on both branches B, C. Furthermore, the optical modulator according to FIG. 8 can comprise at least one illumination device and/or at least one detector device (see FIG. 7).

Switching of objects in the chain of optical components can also take place by influencing the surroundings of the respective object (e.g. the substrate or the adjacent half-space). Instead of a modulator (e.g. 70) an external modulator can also comprise an additional illumination device. The variation of the physical characteristics of at least one object occurs as a result of light radiation

The details which in the above description were stated in relation to the first and second embodiments of the invention can also be implemented in combination. For example, the scanning tips described above can also be provided in an optical modulator according to FIGS. 7 or 8 as an illumination device or as a detector device for the outcoupling of excitation states.

1. A method for acquiring optical near-field interaction signals in the infrared spectral region, comprising the steps of:
illumination of an object combination comprising at least two objects with infrared radiation so that an infrared near-field coupling is generated between the objects; and
acquisition the scattered light which is scattered by the object combination, which scattered light comprises a fraction(s) that has been modified as a result of the near-field coupling, wherein
at least one of the objects comprises a polar material which at least in part comprises a polar solid-state structure; and
during illumination in at least one of the objects with the polar material at least one phonon resonance is excited with which the modified fraction(s) of the scattered light is strengthened.

2. The method according to claim 1, in which acquiring the modified fraction(s) comprises infrared detection with a detector device.

3. The method according to claim 2, in which one of the objects which forms a sample comprises a solid-state surface, an adsorbate on a solid-state surface, or a solid, liquid or gaseous volume material.

4. The method according to claim 2, in which one of the objects which forms a probe comprises a scanning tip of a near-field microscope, a reading head or at least one particle embedded, or suspended in a solid, liquid or gaseous material.

5. The method according to claim 4, in which for optical near-field microscopy the probe and a sample which is to be examined and which forms the associated second object of the object combination are moved step by step relative to each other, and in which method spatially resolved detection of the modified fraction(s) takes place.

6. The method according to claim 4, in which, for optical near-field microscopy, illumination of the object combination takes place with infrared radiation of different wavelengths, wherein in each case spectrally specific detection of scattered light occurs.

7. The method according to claim 4, in which the fraction of the measured scattered light, which fraction has been modified by the near-field coupling, is subjected to spectral analysis.

8. The method according to claim 4, in which, for the purpose of reading out optically stored data, the probe as a reading head is moved over a data carrier which forms the associated second object of the object combination, and detection of a data structure takes place, which data structure has been placed onto, impresses into, or arranged underneath the surface of the data carrier.

9. The method according to claim 5, in which the sample or the data carrier comprises a topography-free surface which comprises structures with differences in the refractive index and with characteristic dimensions which are smaller than 10 μm.

10. The method according to claim 1, in which the acquisition of the modified fraction(s) comprises resonant excitation of at least one adjacent object of a polar material.

11. The method according to claim 10, in which with acquisition of the modified fraction(s) at least one row of objects out of a multitude of objects of a polar material is resonantly excited.

12. The method according to claim 11, in which with the acquisition of the modified fraction(s) several rows of objects of a polar material can be resonantly excited, which rows are interconnected by means of at least one branch.

13. The method according to claim 10, in which physical characteristics, in particular the crystal structure, band structure or charge carrier density of at least one object or of a surrounding of at least one object, are modulated with electromagnetic, electric or magnetic fields so that the dielectric characteristics of the object are changed and the modified fraction(s) of the scattered light which is scattered on the object is modulated accordingly.

14. The method according to claim 13, in which the physical characteristics of the respective object or of its surroundings are modified with high-frequency or low-frequency electromagnetic fields.

15. The method according to claim 12, in which the physical characteristics of an object which is arranged on a branch are modified.

16. The method according to claim 13, in which the modulation of the modified fraction(s) of the scattered light is detected and used as an optical switching signal or for near-field illumination of further object combinations.

17. The method according to claim 1, in which the polar material comprises a III-V-, IV-IV- or II-VI-semiconductor.

18. The method according to claim 1, in which the polar material comprises a ferroelectrical material, SiC, Si₃N₄, CaPO₃, CaCO₃ or SiO₂.

19. A method for infrared spectroscopic examination of a sample, which comprises several components or phases, in which the sample is subjected to scattered-light detection by means of a method according to claim 1, and the components or phases are acquired or analysed depending on the occurrence of specified phonon resonances.

20. A measuring arrangement for measuring the scattered light in the infrared spectral region, comprising,
an illumination device for generating infrared radiation;
a probe device which is arranged so as to be movable at some distance from a sample or so as to be in a sample; and
a detector unit with which the infrared radiation scattered on the probe device is detectable, wherein
the probe device comprises at least one probe which at least partly comprises a material with a polar solid-state structure.

21. The measuring arrangement according to claim 20, in which the probe comprises a III-V-, IV-IV- or II-VI-semiconductor.

22. The measuring arrangement according to claim 20, in which the probe comprises a ferroelectrical material, SiC, Si₃N₄, CaPO₃, CaCO₃ or SiO₂.

23. The measuring arrangement according to claim 20, which is designed as an optical near-field microscope with a scanning tip which carries the probe, and a laser-detector combination for controlling the position of the scanning tip.

24. The measuring arrangement according to claim 20, which is designed as a reading device for an optical data storage device.

25. The measuring arrangement according to claim 20, which is designed as a chemical or physical sensor device.

26. An optical modulator for acquiring or processing optical near-filed interaction signals in the infrared spectral region, comprising:
at least two objects which are arranged on a substrate; and
an illumination device for illuminating the objects with infrared radiation, wherein
the distance between the objects is so short that infrared-near coupling between the objects is produced as a result of radiation,
characterized in that
at least one of the objects consists at least in part of a material that has a polar solid-state structure; and
at least one of the objects is connected to a modulator device for the modulation of physical characteristics, in particular crystal structure, band structure or charge carrier density of the object, of which there is at least one, or of a surrounding of the object of which there is at least one with electromagnetic, electric or magnetic fields.

27. The optical modulator according to claim 26 which comprises at least one detector device with which the infrared radiation scattered on the objects is detectable.

28. The optical modulator according to claim 26, in which at least one row comprising a multitude of objects of a polar material is provided, which objects, when at least one combination of two adjacent objects is illuminated, are mutually excitable so as to be resonant.

29. The optical modulator according to claim 28, in which several rows of objects are provided which are interconnected by way of at least one branch.

30. The optical modulator according to claim 26, in which the objects comprise a III-V-, IV-IV- or II-VI-semiconductor.

31. The optical modulator according to claim 26, in which the objects comprise a ferroelectrical material, SiC, Si₃N₄, CaPO₃, CaCO₃ or SiO₂.

32. The optical modulator according to claim 26, which forms an optical circuit.

33. The optical modulator according to claim 26, in which the illumination device, the detector device or both are arranged on the substrate.

34. The method according to claim 18, in which the ferroelectrical material is barium titanate.

35. The measuring arrangement according to claim 22, in which the ferroelectrical material is barium titanate.

36. The optical modulator according to claim 31, in which the ferroelectrical material is barium titanate.
